(19) United States
(12) Patent Application Publication
(10) Pub. No.: US 2005/0058045 A1
(43) Pub. Date: Mar. 17, 2005

(54) Method of controlling a sled motor control signal

(75) Inventors: Jen-Yu Hsu, Taipei (TW); Hsiang-Yi Fu, Taipei (TW); Tun-Chieh Lee, Taipei (TW); Fu-Hsiang Chen, Taipei (TW); Yao-Chou Tsai, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 10/934,363

(22) Filed: Sep. 7, 2004

(30) Foreign Application Priority Data
Sep. 15, 2003 (TW) 92125294

(51) Int. Cl. G11B 7/00

(52) U.S. Cl. 369/53.25; 369/44.28

(57) ABSTRACT

A method of controlling a sled motor control signal (FMO) is disclosed. First, a predetermined FMO is assigned to move a sled, and a photo signal is monitored. The FMO is off after a predetermined number of waveforms have appeared in the photo signal. Then, a position of an optical pickup is finely adjusted such that the optical pickup is at a center position of a movable range after the seeking operation.

This application claims the benefit of Taiwan application Serial No. 92125294, filed Sep. 15, 2003, the subject matter of which is incorporated herein by reference.

### BACKGROUND OF THE INVENTION

1. Field of the Invention

The invention relates in general to a method of controlling a sled motor control signal (FMO), and more particularly to a method of moving an optical pickup to a center position of its movable range after the seeking operation.

2. Description of the Related Art

Typically, as an optical disk drive receives a read or write command outputted from a host, its seeking servo firstly performs the seeking operation to move the optical pickup to a target track identified by the servo system. The seeking operations are usually divided into a long (rough) seeking operation and a short (fine) seeking operation. The distance of several hundreds of tracks is regarded as the short seeking operation, while the distance of several thousands of tracks is regarded as the long seeking operation. Taking 10,000 tracks as an example, the seeking servo firstly seeks 9500 tracks (long seeking), and then precisely controls the optical pickup to reach the target track according to the short seeking mechanism. Because the invention only relates to the short seeking operation, the following description of the mechanism is made with respect to the short seeking operation.

FIG. 1 is a schematic illustration showing an optical pickup module. The optical pickup module 1 includes an optical pickup 3, a spring 5, a sled 7 and a laser diode (not depicted). When the distance to the target track is not long (e.g., the distance to the optical pickup 3 is only 100 tracks, and the short seeking is performed), the servo system only slightly adjusts the position of the optical pickup 3. The position adjustment is accomplished by the spring 5. The spring 5 only slightly moves the optical pickup 3, as shown in FIG. 1, according to the force coming from the tracking servo system. The servo system detects the position of the target track and then applies the force to the spring 5 to pull the optical pickup 3 to the target track.

After seeking, the optical pickup 3 is usually adjusted to a center position of the sled 7, as shown in FIG. 2(a). Because the track on operation is performed immediately after seeking, the time for track on is longer as the distance from the optical pickup 3 to the center position of the sled 7 is farther. In a serious condition, the track on operation may fail and the servo system cannot judge the position of the optical pickup 3 because the optical pickup 3 is out of the movable range above the sled. Thus, the servo system usually uses a FMO (sled motor control signal) to move the sled 7 during the short seeking and tracking processes, such that the optical pickup 3 is held within its movable range.

FMO is a force voltage for moving the sled 7. The relative position between the optical pickup 3 and the sled 7 is changed according to the movement of the sled 7 such that the position of the optical pickup 3 is within the movable range. How the FMO is utilized to adjust the position of the optical pickup and to keep the optical pickup within its movable range will be described in the following.

As shown in FIG. 2(a), the optical pickup 3 is at the center position of the sled 7. When the optical pickup 3 is performing the short seeking process, the servo system forces the spring 5 to move the optical pickup 3 for seeking in the direction 11. Because the optical pickup 3 is forced, the FMO also starts to force the sled 7, as shown in FIG. 2(b). However, the force of the FMO is insufficient to move the sled due to the relationship between the weight of the sled and the friction force. The optical pickup 3 continues seeking in the direction 11, and the position of the optical pickup 3 is much more deviated from the center position of the sled 7, as shown in FIG. 2(c). At this time, the optical pickup 3 is almost out of its movable range, and the force of the FMO is large enough to push the sled 7. So, the sled 7 is forced to move in the direction 11, and the optical pickup 3 is again back to the center position of the sled 7, as shown in FIG. 2(d). The above-mentioned steps are repeated to move the optical pickup 3 if the seeking process is to be performed continuously.

However, the difference between the dynamic friction force and the static friction force during seeking often causes the optical pickup to be out of the movable range of the sled when it reaches the target track.

As shown in FIG. 3(a), the optical pickup 3 is located at the center position of the sled 7. Because the seeking operation of, for example, 200 tracks, is to be performed, the optical pickup 3 is moved in the direction 11. The force outputting curve of the FMO is shown in FIG. 3(d). When the optical pickup 3 moves 100 tracks to be almost out of the movable range of the sled 7, as shown in FIG. 3(b), the FMO causes a force to be applied to the sled 7 such that the sled 7 is moved in the direction 11. However, because the static friction force of the sled 7 is larger than its dynamic friction force, the sled 7 over slides such that the optical pickup 3 is not at the center position of the sled 7. In a serious condition, the optical pickup 3 may be moved out of its movable range, as shown in FIG. 3(c).

The above-mentioned condition is very disadvantageous to the track on operation after seeking. Thus, much more time has to be spent to perform the track on operation or the track on operation may fail. Hence, the conventional optical disk drive needs a more effective method of controlling the FMO during the short seeking such that the optical pickup is located at the center position of the sled after seeking.

### SUMMARY OF THE INVENTION

It is therefore an object of the invention to provide a method of controlling a FMO in real time when an optical disk drive is seeking in order to solve the problem that an optical pickup is out of a movable range after seeking.

The invention achieves the above-identified object by providing a method of controlling a FMO in real time when an optical disk drive is seeking. First, a predetermined FMO is assigned to move a sled, and a photo signal is monitored. The FMO is off after a predetermined number of waveforms have appeared in the photo signal. Then, a position of an optical pickup is finely adjusted such that the optical pickup is at a center position of a movable range after the seeking operation.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing an optical pickup module.

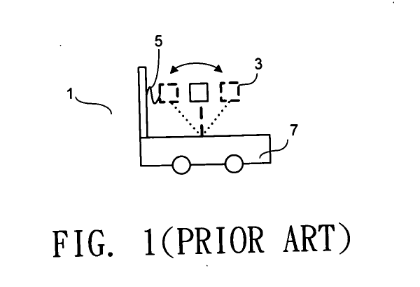

FIGS. 2(a)-2(d) is a schematic illustration showing the relative position between the optical pickup and the sled during the seeking process.

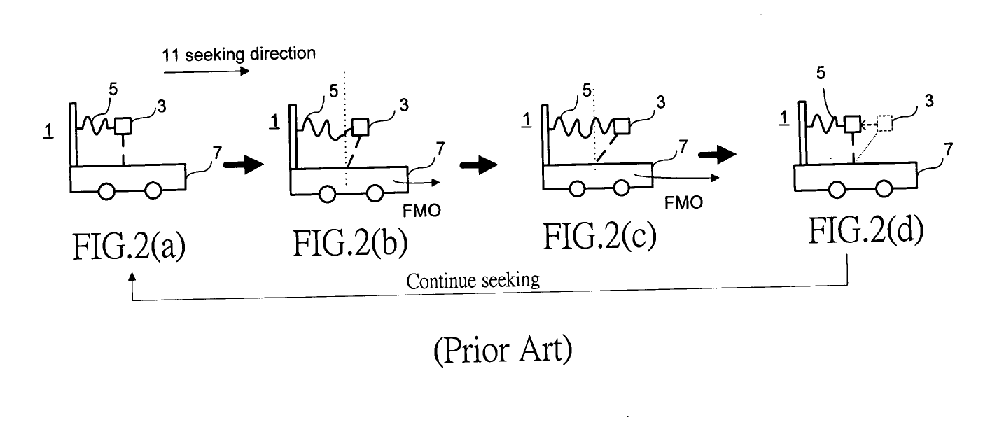

FIGS. 3(a)-3(d) is a schematic illustration showing the relative position between the optical pickup and the sled when the optical disk drive is seeking.

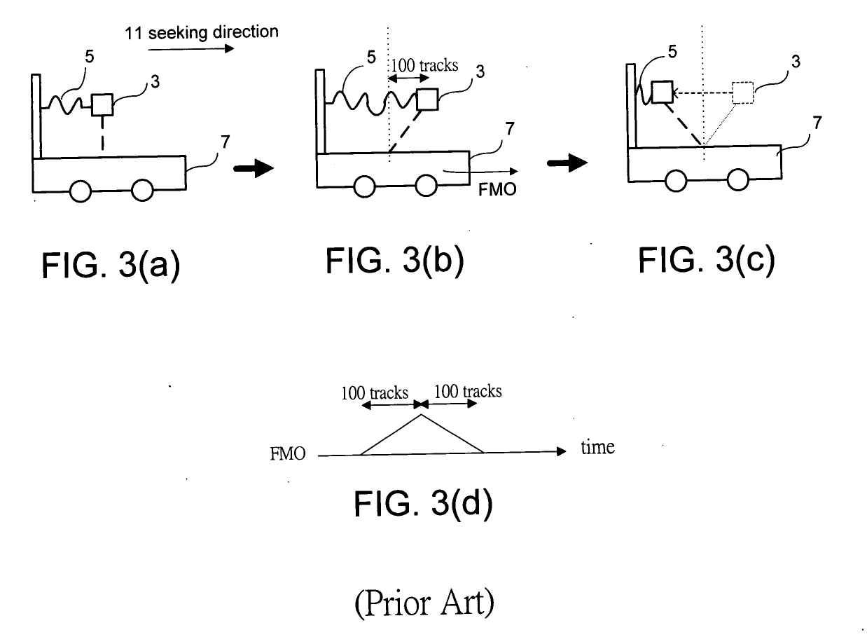

FIG. 4 is a schematic illustration showing a photo interrupter and a photo signal.

FIGS. 5(a)-5(b) is a schematic illustration showing a FMO and a photo signal of the invention.

FIGS. 6(a)-6(c) is a schematic illustration showing the relative position between the sled and the optical pickup during the seeking process in the invention.

### DETAILED DESCRIPTION OF THE INVENTION

Typically, the sled is moved to make the optical pickup locate within its movable range according to the FMO when the optical disk drive is performing the short seeking process. However, because the difference between the static friction force and the dynamic friction force exerted on the sled is too great, the optical pickup after seeking is not within the movable range. In order to overcome the above-mentioned problem, the invention proposes a method of controlling the FMO in real time during seeking.

The invention utilizes a photo signal to assist the method of controlling the FMO in real time. The generation of the photo signal and its representative physical meaning will be described in the following.

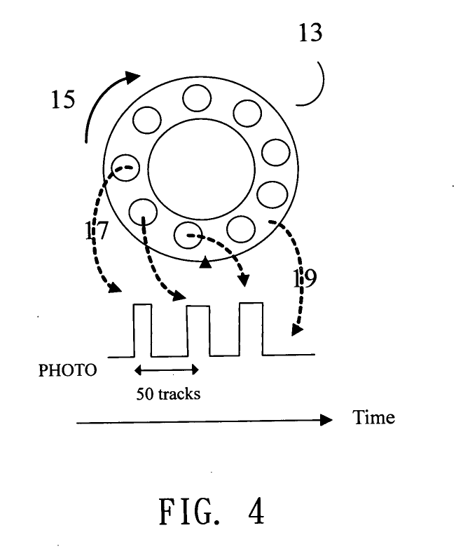

FIG. 4 is a schematic illustration showing a photo interrupter. When the optical disk drive is enabled, the photo interrupter 13 rotates in the direction 15. When the laser light reflected from the optical disk passes through the transparent region 17 of the photo interrupter 13, a waveform appears in the photo signal (PHOTO). Inversely, if the laser light passes through the opaque region 19 of the photo interrupter 13, no waveform is generated. Because the rotating speed of the photo interrupter is fixed, the sled just seeks 50 tracks during the interval time between the generated waveforms in the photo signal, as shown in FIG. 4. Typically, the tracking error signal for calculating the seeking number represents that the optical pickup has sought one track after a cycle of waveform, which is greatly different from the photo signal representing that the sled has sought 50 tracks during a cycle of waveform. Thus, the photo signal is usually used to calculate the seeking number of the long seeking, but the tracking error signal is used to calculate the seeking number of the short seeking.

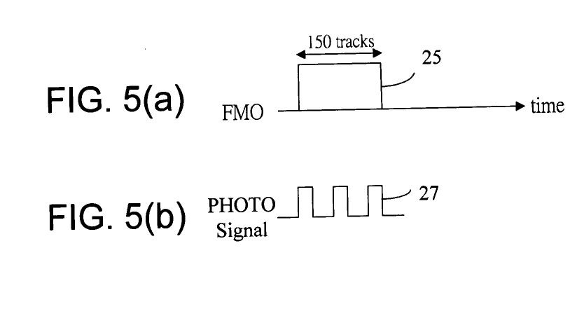

The invention controls and adjusts the FMO during seeking in real time according to the photo signal. FIG. 5 is a schematic illustration showing a FMO and a photo signal of the invention. Assume that the servo system outputs a command for seeking 200 tracks, because one cycle of the photo signal waveform 27 represents that the sled has passed 50 tracks, the FMO 25 is set to be a constant, as shown in FIG. 5(b) to make the sled slide. At this time, the photo signal 27 is monitored. When three cycles of waveforms appear in the photo signal 27, the FMO 25 is off immediately. The sled 7 gradually slows down and finally stops. At this time, the number of tracks from the optical pickup 3 to the target track is calculated. Then, the optical pickup 3 is caused to be located at the center position of the sled 7 as it reaches the target track using the optical pickup to finish the seeking according to the number of remaining tracks that is not sought.

The reason why the sled motor 25 is off when only three cycles have appeared in the photo signal is because that the sled 7 has been moved 200 tracks from the time when the sled 7 starts to slide to the time after four cycles have appeared in the photo signal 27 and then the photo signal is off. In this case, the optical pickup 3 does not tend to be located at the center position of the sled 7 even it is moved. Consequently, the remaining number of tracks of the sled is otherwise made by finely adjusting the optical pickup 3 to make it reach the target track after three cycles have appeared in the photo signal (i.e., the sled has slid 150 tracks).

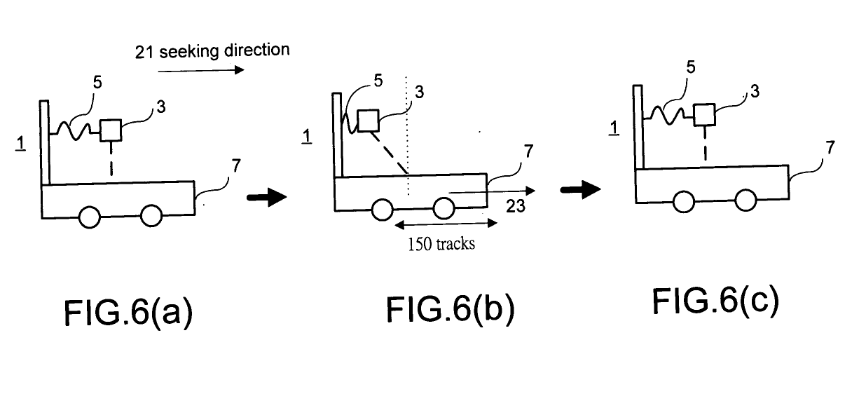

FIG. 6 is a schematic illustration showing an optical pickup module of the invention when 200 tracks are sought. When the servo system outputs a command to seek 200 tracks in the direction 21, the optical pickup 3 is located at the center position of the sled 7, as shown in FIG. 6(a). The servo system directly gives the FMO a bias to enable the sled 7 to slide in the direction 23. At this time, the optical pickup 3 is getting more and more deviated from the center position of the sled 7 owing to the inertial, as shown in FIG. 6(b). After three cycles have appeared in the photo signal (i.e., the sled has been moved 150 tracks), the FMO is immediately off, so no force is applied to the sled 7. The sled 7 gradually slows down and finally stops. Thereafter, the spring 5 is used to adjust the optical pickup 3 to finish the number of remaining tracks. Consequently, when the optical pickup 3 finishes the seeking of 200 tracks, its position is just located at the center position of the sled 7.

Therefore, the advantage of the invention is to utilize the existing hardware apparatus to achieve the position correction for the optical pickup after seeking. Therefore, it is possible to solve the problem that the optical pickup is out of its movable range after seeking owing to the great difference between the dynamic and static friction forces after the prior art seeking process.

Another advantage of the invention is to effectively shorten the required time for the track on operation. The invention firstly controls the FMO to move the sled by most of the tracks (coarse adjustment), and then utilizes the spring to finely adjust the position of the optical pickup. Compared to the prior art, which utilizes the spring to finely adjust the optical pickup to perform the short seeking, the invention is more precise. Thus, the optical pickup after seeking is located at the center position of the sled, which is quite advantageous to the following track on operation, and the required time for track on may be effectively shortened.

Of course, the invention is not limited to the only application of the short seeking because the long seeking and the short seeking are mixed during the seeking process and definitions of the long and short seeking processes are recognized by the firmware of the servo system. So, the above-mentioned invention is not restricted to the short seeking application of only several hundreds of tracks.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of controlling a sled motor control signal (FMO) in real time during seeking in an optical disk drive, the method comprising the steps of:
assigning the FMO a constant to make a sled slide and monitoring a photo signal;
turning off the FMO and calculating a distance from an optical pickup to a target track when a predetermined number of waveforms appear in the photo signal; and
moving the optical pickup to the target track to locate the optical pickup at a predetermined position.

2. The method according to claim 1, wherein the photo signal is a signal generated after reflected light passes through a photo interrupter.

3. The method according to claim 1, wherein each time the waveform of the photo signal appears represents that the sled has moved a plurality of fixed number of tracks.

4. The method according to claim 1, wherein the predetermined number is determined according to a seeking length.

5. The method according to claim 1, wherein the predetermined position is a center position, at which the optical pickup is located, in a movable range of the sled.

6. The method according to claim 1, wherein the FMO is a force voltage of the sled.

7. A method of controlling a sled motor control signal (FMO) in real time during seeking in an optical disk drive, the method comprising the steps of:
calculating the number of tracks from an optical pickup to a target track;
determining a predetermined number of waveforms that should appear in a photo signal according to the number of tracks;
assigning the FMO a constant to make a sled slide;
turning off the FMO and calculating a distance from the optical pickup to the target track when the predetermined number of waveforms appear in the photo signal; and
moving the optical pickup to the target track such that the optical pickup is located at a predetermined position.

8. The method according to claim 7, wherein the photo signal is a signal generated after reflected light passes through a photo interrupter.

9. The method according to claim 7, wherein each time the waveform of the photo signal appears represents that the sled has moved a plurality of fixed number of tracks.

10. The method according to claim 7, wherein the predetermined position is a center position, at which the optical pickup is located, in a movable range of the sled.

11. The method according to claim 7, wherein the FMO is a force voltage of the sled.
